(19) United States
(12) Patent Application Publication
(10) Pub. No.: US 2011/0070379 A1
(43) Pub. Date: Mar. 24, 2011

(54) LIGHT AND UV STABILISERS

(75) Inventors: JOHN Z. FANG, Parsippany, NJ (US); David Tan, Selangor D.E. (MY); Terry Scoville, Kennesaw, GA (US)

(73) Assignee: CYTEC TECHNOLOGY CORP., Wilmington, DE (US)

(21) Appl. No.: 12/767,488

(22) Filed: Apr. 26, 2010

(30) Foreign Application Priority Data
Mar. 11, 2009 (EP) 09154830.5
Mar. 10, 2010 (TW) 99106869

(51) Int. Cl. C09D 139/04; C08F 2/46; B05D 3/02

(52) U.S. Cl. 427/521; 523/135; 427/385.5

(57) ABSTRACT

A light stabiliser AS comprising a surface-active or amphiphilic part A which leads to migration of the stabiliser to the surface of a material during the process of formation of a surface, and solidification of the material, and a stabilising part S which is the photochemically active ingredient and transforms the energy of the incident light to vibrational or heat energy that is dissipated within the material, characterised in that both parts are connected by a chemical bond in the form of a single or multiple bond or of an at least divalent bridging group

### FIELD OF THE INVENTION

The invention relates to light and UV stabilisers, to a method of making these, and to a method of use thereof comprising adding the stabilisers to the substrate while the substrate is in a liquid state.

### BACKGROUND OF THE INVENTION

Light and UV stabilisers protect a material, hereinafter also referred to as substrate, against photochemical degradation. Photochemical degradation is caused primarily by absorption of light by a material, whereby electrons are promoted to an excited state, and the material in such an electronically excited state can react by cleavage or formation of chemical bonds. Such a primary photo-induced chemical reaction can lead to secondary reactions that involve changes in the molecules of the substrate or material, where usually such reactions impair the physical properties of the material, leading to i.a. chalking, yellowing, loss of gloss, and formation of microcracks or cracks.

It is therefore common practice to add light stabilisers to materials used to make plastic objects, films, or surface coatings if these are to be exposed to light, particularly to visible and ultra-violet (UV) light. Use of light stabilisers is not needed in the case of metals which generally do not suffer from photochemical degradation, due to their special structure where electrons reside in energy states that are referred to as valence and conduction bands. Most or all other materials, however, particularly organic materials, are prone to impairment by the action of radiation such as light.

Incident light, including UV light, generally only penetrates the surface layer of any massive body because of the scattering of light in materials which occurs even in transparent materials. The common methods of protecting materials against the undesirable action of light imply adding a stabiliser, i.e. a substance which absorbs light to an elevated extent, compared to the material to be protected, and dissipates the absorbed energy within the material in the form of heat (vibrational energy). The stabiliser is evenly distributed within the material, and the major part of this stabiliser is therefore not prone to be subjected to the action of light, and is therefore unused.

In the investigations made in connection with the present invention, it has been found that concentration of the stabiliser in the surface layer of the material to be protected would make better use of the stabiliser, and increase the efficiency with regard to the amount of stabiliser used.

Fixing a light stabiliser to the surface of polyolefin films has been known from “A novel photoadditive for polyolefin photostabilisation: Hindered amine light stabiliser” by DESAI Shrojal M., PANDEY Jitendra K., and SINGH R. P., “Die Makromolekulare Chemie—Macromolecular symposia”, Eurofillers '99 Conference, vol. 169, pp. 121 to 128, where hindered-amine light stabilisers were surface anchored to polyethylene and polypropylene thin films by direct photo-grafting of 1,2,2,6,6-pentamethyl piperidinyl-4-acrylate onto the surface, or by reacting of 1,2,2,6,6-pentamethyl-4-piperidinol with succinic anhydride functionalised polyolefin surface.

This method involves a complicated additional treatment step, where the polymeric article to be protected must be modified by chemically linking the stabiliser to the polymer surface. If only a part of the polymer molecules is modified according to these prior art documents, and these modified polymer molecules are admixed to non-modified polymer for subsequent forming in a melt process such as injection moulding, extrusion, or rotomoulding, the modified polymer becomes evenly distributed within a polymeric article formed by such melt process, just as in the case of just adding a non-polymer bound stabiliser. If it is desired to concentrate the stabiliser near or on the surface, a surface treatment of the final article is needed which involves an additional step after forming the polymeric article, such as films, fibres, bottles, or injection moulded articles. It is therefore an object of the invention to provide a class of light stabilisers that allows concentration of a stabiliser in the region of the surface of a material to be protected which does not involve such an additional surface modification step.

### SUMMARY OF THE INVENTION

This object has been realised by providing a surface-active or amphiphilic light stabiliser that is distributed within a material while this is in a liquid state. The amphiphilic light stabiliser comprises a surface-active or amphiphilic part which leads to migration of the stabiliser to the surface of the said material during the process of formation of a surface, and solidification of the material, and a stabilising part which is the photochemically active ingredient and transforms the energy of the incident light to vibrational or heat energy that is dissipated within the material. Both parts are connected by a chemical bond in the form of a single or multiple bonds or of an at least divalent bridging group.

The invention therefore relates to a surface-active or amphiphilic light stabiliser AS comprising a structural moiety A which has surface-active or amphiphilic character, and a structural moiety S which is capable of absorbing visible and ultraviolet light.

The invention also relates to a coating composition comprising a binder B, and a surface-active or amphiphilic light stabiliser AS which upon crosslinking and solidification of the coating composition to form a coating film on a substrate, migrates to the surface of the said film in a way that the mass fraction of the surface-active or amphiphilic light stabiliser AS in a layer immediately adjacent to the surface of the said coating film is at least 10% higher than the mass fraction of the surface-active or amphiphilic light stabiliser AS in a layer in the centre of the coating film.

### DETAILED DESCRIPTION OF THE PREFERRED EMBODIMENTS

For the purpose of this invention, by a layer immediately adjacent to the surface of the coating film is meant a layer that extends from the surface of the coating film which is not in contact with the substrate up to a depth of 2.5 μm beneath that surface.

The mass fraction of light stabiliser in the coating film layers can be determined in the usual way, particularly using spectroscopic methods such as IR, UV, and Mass Spectroscopy.

By “surface-active”, a compound or composition is meant that changes the surface tension of a substance when admixed to the said substance, in a way that the surface tension of the said substance is different from the surface tension of a mixture comprising the said substance and the surface-active compound or composition. The surface-active part is preferably a polymer or oligomer, preferably formed by a vinyl type polymerisation process which can be initiated by radicals.

A molecule is said to have a hindered amine structure if it has an amine functional group which is surrounded by a crowded steric environment, also referred to in the literature as “sterically hindered amine”. A molecule is said to have a benzophenone structure if two aromatic rings are connected by a carbonyl group, >C═O. A molecule is said to have a benzotriazole structure if there is a triazole ring (a five-membered ring having three nitrogen atoms in the ring in 1,2,3-sequence) that has two adjacent carbon atoms in common with a further aromatic ring. A molecule is said to have a triazine structure if there are three non-adjacent nitrogen atoms in a six-membered aromatic ring.

In one embodiment, the surface-active part is amphiphilic and comprises two moieties: a first moiety C that is compatible with the material of the polymer or coating composition to be stabilised, particularly the binder in a coating composition. This moiety C is regarded as compatible if there are no visible phase separation effects in a mixture of the binder or a polymer and a molecule corresponding to that first moiety in mixtures comprising up to a mass fraction of 5% of the molecule corresponding to that first moiety. The second moiety N of the surface active part A of the stabiliser AS is incompatible with the binder or polymer and forms a phase separate from the binder or polymer if the mixing ratio allows.

A molecule is said to correspond to a moiety if a hydrogen atom or a methyl group is added to the radical which forms the said moiety. Preferably, the mass fraction up to which no phase separation is seen in a compatible system is up to 10%. A visible phase separation is indicated by formation of separate layers, or development of turbidity in the mixture that can be seen with the naked eye. In a polymer, such as a thermoplastic resin, phase separation can also be detected by showing different transition temperatures in a differential scanning calorimeter, or a torsional pendulum.

If a molecule corresponding to the second moiety N of the amphiphilic part is mixed with the polymer or binder to form a homogeneous molten or liquid mixture with a mass fraction of at least 5% of the molecules corresponding to the second moiety N of the amphiphilic part A, this mixture will form separate phases after twenty-four hours or less after mixing, kept at the same temperature that was used for mixing. Formation of separate phases is indicated by macroscopic phase separation, or by the development of turbidity which can be detected with the naked eye.

The stabilising part S of the stabilisers AS according to the invention is preferably derived from the well-known light or UV stabilisers, preferably based on the so-called hindered amines, on molecules having a benzophenone structure, molecules having a benzotriazole structure, and molecules having a triazine structure. In the context of this invention, by “a part . . . derived from” is meant that a hydrogen atom or a methyl group is cleaved from a molecule, in this case a light stabiliser molecule, to yield a radical which is then referred to as a “part”. For example, a hydrogen atom in the 3′-position of (2-hydroxy-4-methoxyphenyl)-phenylmethanone (also referred to by its trivial name “oxybenzone”) could be taken away to form a radical which would be addressed here as a “part of oxybenzone”.

The stabilising part S and the amphiphilic or surface-active part A of the light stabiliser AS according to the invention are linked together by an at least divalent bridge forming at least one chemical bond with the a surface-active or amphiphilic part A, and at least one chemical bond with the stabilising part S. Preferably, the at least divalent bridging group comprises at least one structure of the formula —CR¹R²—CR³R⁴—, wherein any of the radicals —R¹, —R², —R³ and —R⁴ may be independently of each other, —H, —F, —Cl, —CH₃, —OH, —OCH₃, an alkyl radical —CₙH₂ₙ₊₁, an oxyalkyl radical —O—CₙH₂ₙ₊₁, where n is in each case independently, from 2 to 18, an aryl radical, and an oxyaryl radical. This structure may be directly bonded to the stabilising part, and the divalent bridge may also comprise additional ester structures —O—CO—, urethane groups —NH—CO—, urea groups —NH—CO—NH, or 2-hydroxy-1,3-propylene groups —CH₂—CH(OH)—CH₂—, or any combination thereof. Linking is preferably effected by addition of a carboxylic acid group, or an aliphatic hydroxyl group connected to the structure of the stabilising part via a flexible spacer group, and addition of an olefinically unsaturated function via reaction of e.g., an acid function with glycidyl (meth)acrylate, under formation of an ester bond, or reaction of a hydroxyl function with the reaction product of 1 mol of (meth)acrylic acid with 1 mol of a diisocyanate, under formation of a urethane bond.

Further preferred embodiments of the invention are detailed in the claims.

Preferably, the material comprising the surface-active or amphiphilic light stabiliser AS is a coating composition comprising a binder B where the surface-active or amphiphilic light stabiliser AS is evenly dispersed in the coating composition. Upon coating a substrate, a film is formed by the material of the coating composition on the substrate. During formation of the film, by evaporation of a solvent which may be an organic solvent or water, the hydrophilic or hydrophobic character of the coating composition is changed. This change is particularly pronounced in aqueous dispersed binders in a coating composition. In this case, a proper choice of the amphiphilic part A of the amphiphilic light stabiliser AS is to build the amphiphilic part by a portion C that is compatible with the polymeric binder B or the polymer, in the case of stabilisation of a melt-processable polymer, particularly one which has the same or a very similar chemical structure, and one portion N that does not form a homogenous mixture with the polymeric binder, particularly having a different chemical structure.

It has been found that some polymers being copolymers of two or more monomers that differ in their chemical structure can act as amphiphilic parts A of the stabilisers AS according to this invention. Examples for these are vinyl copolymers having fluorine-containing structures derived from fluoro monomers such as esters of fluorinated alcohols and olefinically unsaturated acids. Other copolymers with amphiphilic properties in the context of this invention are acrylic copolymers having hydroxyl or acid functional groups, such as olefinically unsaturated acids themselves, preferably acrylic or methacrylic acids, or esters thereof with polyhydric alcohols, preferably hydroxyethyl acrylate or hydroxyethyl methacrylate. Block copolymers comprising at least one segment which is compatible with the polymer to be stabilised, and one segment that forms a separate phase, are also useful for the invention, and are particularly preferred in the case of thermoplastic or heat-setting polymers.

A similar effect of migration of the surface-active or amphiphilic light stabiliser towards the surface of the coating film can be seen in radiation curable binders for coatings. Here the choice for the surface-active or amphiphilic part has to be made such that the monomeric or oligomeric binder molecules which form the radiation-curable coating composition form a homogeneous solution or dispersion with the surface-active or amphiphilic light stabiliser AS. Upon polymerisation which is induced by irradiating the wet coating film, formation of the polymer leads to a decrease in the solubility of the surface-active or amphiphilic light stabiliser, which decreasing solubility also leads to a migration of the surface-active or amphiphilic light stabiliser towards the surface of the coating film which is in the process of formation.

Another similar effect can be realised in light stabilisation of objects made of thermoplastic polymers that crystallise upon solidification, such as polyolefins, polyesters, polyamides, or polyacetal. By choosing the surface-active or amphiphilic part of the surface-active or amphiphilic light stabiliser so that there is only a weak tendency to co-crystallise with the solidifying thermoplastic polymer, the light stabiliser is also exuded towards the surface of the object. This tendency can also be increased by adding nucleation agents to the polymer which promotes crystallisation, and hence, migration of the surface-active or amphiphilic light stabiliser AS.

The same effect can be seen in a coating prepared from a powder coating composition: upon solidification of the film on the substrate, and particularly marked in the case of a powder coating binder based on a crystalline polymer, the light stabiliser is exuded towards the surface. This can be promoted by applying the powder coating to a substrate which is colder on its surface than the ambient. The light stabiliser is then preferentially concentrated in the zone which is still liquid, thus further enhancing the migration of the surface-active light stabiliser AS towards the surface of the coating film.

A preferred embodiment of a method of use of the light stabiliser therefore comprises adding the said stabiliser to a thermoplastic polymer in a mass fraction of from 0.1% to 5%, based on the sum of the masses of the said thermoplastic polymer and the said light stabiliser, melting the mixture of the said thermoplastic polymer and the said light stabiliser, mixing the molten mixture, and solidifying the molten mixture by cooling.

A further preferred embodiment of a method of use of the light stabiliser therefore comprises adding the said stabiliser to a thermosetting polymeric material in a mass fraction of from 0.1% to 5%, based on the sum of the masses of the said thermosetting polymeric material and the said light stabiliser, heating the mixture of the said thermosetting polymeric material and the said light stabiliser to a temperature below the curing temperature of the said thermosetting polymer, mixing the molten mixture, and solidifying the molten mixture by heating to a temperature equal or greater than the curing temperature of the said thermosetting polymeric material.

A further preferred embodiment of a method of use of the light stabiliser therefore comprises adding the said stabiliser to a crosslinkable polymeric binder dissolved in an organic solvent in a mass fraction of from 0.1% to 5%, based on the sum of the masses of the said crosslinkable polymeric binder and the said light stabiliser, to form a coating composition, mixing the said coating composition, applying the mixed coating composition to a substrate to form a film on the substrate, heating the coated substrate to a temperature sufficient to remove at least a part of the solvent, and crosslinking the said film on the said substrate by heating or subjecting the coated substrate to radiation.

A further preferred embodiment of a method of use of the light stabiliser therefore comprises adding the said stabiliser to a crosslinkable polymeric binder dispersed or emulsified in water in a mass fraction of from 0.1% to 5%, based on the sum of the masses of the said crosslinkable polymeric binder and the said light stabiliser, to form a coating composition, mixing the said coating composition, applying the mixed coating composition to a substrate to form a film on the substrate, heating the coated substrate to a temperature sufficient to remove at least a part of the solvent, and crosslinking the said film on the said substrate by heating or subjecting the coated substrate to radiation.

The invention is further explained by the following examples which are not to be construed as limiting.

### EXAMPLES

### Example 1

### Preparation of a Polymeric Light Stabiliser

A glass reactor having a volume of 500 ml equipped with reflux condenser, stirrer, and two feeding pumps was charged with 50 g of isopropanol. The contents were heated to reflux, and a mixture of 0.7 g of t-amyl peroxy (2-ethylhexanoate) (®Lupersol 575, Pennwalt Corp.), 140 g of ethyl acetate, 5 further g of isopropanol, 50.1 g of butyl acrylate, 22.8 g of 2-ethylhexyl acrylate, and 26 g of (2-hydroxy-4-[2-acryloxy]-ethoxyphenyl)-phenylmethanone, an olefinically unsaturated substituted benzophenone, was gradually added over two hours. The mixture was kept at reflux temperature under stirring for another hour, and then, a second mixture of 0.6 g of t-amyl peroxy (2-ethylhexanoate), 5 g of isopropanol, 21.4 g of butyl acrylate, and 9.7 g of 2-ethylhexylacrylate was added to the reaction mixture in the course of two further hours. Reaction was then brought to completion by keeping the mixture at reflux temperature for one and one half more hours, and finally, residual monomers, solvent and by-products from the decomposition of the radical initiator were removed by distillation under reduced pressure. The resulting polymer was cooled to 65° C., and filtered through a filter having a pore size of 25 μm. The polymer obtained in a yield of 99.1% was light yellow and viscous, and had a weight average molar mass of 12.2 kg/mol, as determined by gel permeation chromatography using a polystyrene standard. The polymer was referred to as “UV-1”. The mass fraction of 2-hydroxybenzophenone moieties in this polymer was 20%.

### Example 2

### Preparation of a Siloxane-Modified Polymeric Light Stabiliser

A glass reactor having a volume of 500 ml equipped with reflux condenser, stirrer, and two feeding pumps was charged with 50 g of isopropanol. The contents were heated to reflux, and a mixture of 0.7 g of t-amyl peroxy (2-ethylhexanoate) (®Lupersol 575, Pennwalt Corp.), 140 g of ethyl acetate, 5 further g of isopropanol, 50.1 g of butyl acrylate, 20 g of 2-ethylhexyl acrylate, 3.9 g of vinyl terminated poly-siloxane, and 26 g of (2-hydroxy-4-[2-acryloxy]-ethoxyphenyl)-phenylmethanone, an olefinically unsaturated substituted benzophenone, was gradually added over two hours. The mixture was kept at reflux temperature under stirring for another hour, and then, a second mixture of 0.6 g of t-amyl peroxy (2-ethylhexanoate), 5 g of iso-propanol, 21.4 g of butyl acrylate, and 8.6 g of 2-ethylhexylacrylate was added to the reaction mixture in the course of two further hours. Reaction was then brought to completion by keeping the mixture at reflux temperature for one and one half more hours, and finally, residual monomers, solvent and by-products from the decomposition of the radical initiator were removed by distillation under reduced pressure. The resulting polymer was cooled to 65° C., and filtered through a filter having a pore size of 25 μm. The polymer obtained in a yield of 98.8% was light yellow and viscous, and had a weight average molar mass of 12.5 kg/mol, as determined by gel permeation chromatography using a polystyrene standard. The polymer was referred to as “UV-2”. The mass fraction of 2-hydroxybenzophenone moieties in this polymer was 20%.

### Example 3

### Preparation of Coatings

Coating compositions based on an acrylic binder resin were prepared according to the formulations of table 1. These were stabilised with the polymeric stabilisers of Examples 1 and 2 (UV-1 and UV-2), and with a conventional benzophenone type light stabiliser (“Comp.”, 2-hydroxy-4-(2-ethylhexoxy)-benzophenone), a non-stabilised sample being included as reference. These coating compositions were applied to sheets of cold roll steel having been subjected to a CED (cathodic electrodeposition) primer treatment and white basecoat before, to give a dry film thickness of from 45 μm to 50 μm (1.8 mils to 2.0 mils) after drying for 30 minutes at 140° C.

TABLE 1
Coating formulations A to D

| Constituents† | A | | B | | C | | D | |
|---|---|---|---|---|---|---|---|---|
| Acrylic Resin* | 75 | g | 75 | g | 75 | g | 75 | g |
| Melamine Crosslinker Resin†† | 25 | g | 25 | g | 25 | g | 25 | g |
| Acid Catalyst (DDBSA)‡ | 0.7 | g | 0.7 | g | 0.7 | g | 0.7 | g |

| UV-1 (Example 1) | 1 | g | 0 | | 0 | | 0 |
|---|---|---|---|---|---|---|---|
| UV-2 (Example 2) | 0 | | 1 | g | 0 | | 0 |
| Comp. Light Stabiliser | 0 | | 0 | | 2 | g | 0 |
| HALS¤ | 1 | g | 1 | g | 1 | g | 0 |

†a solvent mixture of butanol (15 g), xylene (18 g) and PM Acetate (propylene glycol monomethylether acetate, 18 g) was added to all formulations
*hydroxyfunctional acrylic resin dissolved in a mixture of alkylated aromatics-®Solvent Naphtha, mass fraction of solids 65%, acid number 22 mg/g, hydroxyl number 120 mg/g
††highly methylated melamine formaldehyde resin, 3800 mPa · s at 25° C., mass fraction of free formaldehyde less than 0.3%
‡DDBSA = dodecylbenzene sulphonic acid
¤mixture of mono- and bis-ester of 1,2,2,6,6-pentamethyl-4-piperidol and sebacic acid (®Tinuvin 262, Ciba Specialty Chemicals Inc.)

The mass fraction of the 2-hydroxybenzophenone moiety is 0.2% for both coating composition A and B, and 2.0% for coating composition C. Composition D is a non-stabilised control.

These coated steel panels (panel A coated with coating composition A, panel B coated with coating composition B, panel C coated with coating composition C, panel D coated with coating composition D) were subjected to a Xenon Weathering Test in accordance with ASTM G 155 (at 0.35 W/m² and (63±3)° C.; cycles of 102 minutes of irradiation followed by 18 minutes of irradiation and water spray). Change in yellowness in the coating film was monitored after a specified exposure time, the results are compiled in table 2.

Yellowness (Δb) is measured with a customary instrument (BYK Gardner Spectrophotometer) and calculated according to ASTM E 313.

TABLE 2
Change in yellowness (Δb) after irradiation

| Δb after | 500 h | 1000 h | 1500 h | 2000 h | 3000 h | 4000 h | 5000 h |
|---|---|---|---|---|---|---|---|
| panel A | 0.09 | 0.29 | 0.34 | 0.49 | 0.6 | 0.8 | 0.94 |
| panel B | 0.1 | 0.35 | 0.37 | 0.49 | 0.6 | 0.7 | 0.88 |
| panel C | 0.35 | 0.66 | 0.73 | 0.91 | 1.2 | 1.4 | 1.67 |

| | | | | | | |
|---|---|---|---|---|---|---|
| panel D | 0.56 | 1.31 | 2.06 | 3.39 | 8.4 | failed |

It can be seen that although the mass fraction of the stabilising structure, 2-hydroxybenzophenone, in coating compositions A and B, is only 10% of that of coating composition C (here, a mass fraction of 2.0%), the protection against yellowing caused by UV light is far lower in the coating composition comprising the conventional UV stabiliser, than in the case of the UV stabilisers according to the invention, in coating compositions A and B.

### Example 4

### Preparation of a Polymeric Light Stabilizer Based on Benzotriazole

A glass reactor having a volume of 500 ml equipped with reflux condenser, stirrer, and two feeding pumps was charged with 70 g of isopropanol. The contents were heated to 80° C., and a mixture of 0.5 g of t-amyl peroxy (2-ethylhexanoate) (®Peroxan APO, Pergan GmbH), 5 g of ethyl acetate, 50 further g of isopropanol, 36.0 g of butyl acrylate, 14.0 g of 2-ethylhexyl acrylate, and 6.80 g of oxiranylmethyl methacrylate was gradually added over two hours. The mixture was kept at 80° C. under stirring for another hour, and then, a second mixture of 0.5 g of t-amyl peroxy (2-ethyl-hexanoate), 5 g of isopropanol, 20 g of ethyl acetate, 15.2 g of butyl acrylate, and 6.0 g of 2-ethylhexylacrylate and 2.0 g of oxiranylmethyl methacrylate was added to the reaction mixture in the course of one further hour. Reaction was then brought to completion by keeping the mixture at 80° C. for one more hour, and finally, residual monomers, solvent and by-products from the decomposition of the radical initiator were removed by distillation under reduced pressure. The resulting polymer was then dissolved in 20 g xylene and heated to 150° C. 20.0 g of 3-[3-(2H-Benzotriazol-2-yl)-5-tert-butyl-4-hydroxyphenyl]propionic acid (acid functional benzotriazole, CAS#84268-36-0) were added and the temperature maintained until the acid number of the reaction mixture was below 3 mg/g (measured according to DIN EN ISO 2114). Further xylene was added to obtain a mass fraction of solids of 50%. The resulting polymer had a weight average molar mass of 11.3 kg/mol, as determined by gel permeation chromatography using a polystyrene standard. The polymer was referred to as “UV-3”.

### Example 5

### Preparation of an Acid Functional Triazine Intermediate

### Synthesis of [4-[4,6-bis(2,4-dimethylphenyl)-1,3,5-triazin-2-yl]-3-hydroxyphenoxy]-acetic acid ethyl ester

The compound [4-[4,6-bis(2,4-dimethylphenyl)-1,3,5-triazin-2-yl]-3-hydroxyphenoxy]-acetic acid ethyl ester was synthesised following the procedure described in U.S. Pat. No. 6,265,576 (column 40; compound A) wherein 800 g of 2-(2,4-dihydroxyphenyl)-4,6-bis-(2,4-dimethylphenyl)-1,3,5-triazine were reacted for 9 h at 60° C. with 270 g of ethyl chloroacetate in 5000 ml of acetone solvent containing 692 g of anhydrous potassium carbonate as acid scavenger and 33.2 g of potassium iodide as a catalyst. The crude product, as described in the example, was recrystallised from a mixture of equal masses of methylene chloride and methanol to obtain purified [4-[4,6-bis(2,4-dimethylphenyl)-1,3,5-triazin-2-yl]-3-hydroxyphenoxy]-acetic acid ethyl ester.

### Example 6

### Preparation of a Polymeric Light Stabilizer Based on Hydroxyaryl Triazine

A glass reactor having a volume of 500 ml equipped with reflux condenser, stirrer, and two feeding pumps was charged with 80 g of isopropanol. The contents were heated to reflux, and a mixture of 0.6 g of t-amyl peroxy (2-ethylhexanoate) (®Peroxan APO, Pergan GmbH), 40 g of ethyl acetate, 36.0 g of butyl acrylate, 14.0 g of 2-ethylhexyl acrylate, 5.0 g of oxiranylmethyl methacrylate and 1.0 g of vinyl terminated polydimethylsiloxane was gradually added over two hours. The mixture was kept at reflux temperature under stirring for another hour, and then, a second mixture of 0.4 g of t-amyl peroxy (2-ethylhexanoate), 30 g of ethyl acetate, 16.2 g of butyl acrylate, 6.0 g of 2-ethylhexylacrylate and 1.8 g of oxiranylmethyl methacrylate was added to the reaction mixture in the course of one further hour. Reaction was then brought to completion by keeping the mixture at reflux temperature for one more hour, and finally, residual monomers, solvent and by-products from the decomposition of the radical initiator were removed by distillation under reduced pressure. The resulting polymer was then dissolved in 25 g xylene and heated to 150° C. 20.0 g of the intermediate from Example 5 ([4-[4,6-Bis(2,4-dimethylphenyl)-1,3,5-triazin-2-yl]-3-hydroxyphenoxy]-acetic acid) were added and the temperature maintained until the acid number of the reaction mixture was less than 3 mg/g (as measured according to DIN EN ISO 2114). Further xylene was added to obtain a mass fraction of solids of 50%. The polymer had a weight average molar mass of 10.8 kg/mol, as determined by gel permeation chromatography using a polystyrene standard. The polymer was referred to as “UV-4”.

### Example 7

### Preparation of Coatings

Coating compositions E, F, G, and H based on an acrylic binder resin were prepared according to the formulations of table 3. These were stabilised with the polymeric stabilisers of Examples 4 and 6 (UV-3 and UV-4), and with a conventional benzotriazole type light stabiliser (®Tinuvin 1130, Ciba Specialty Chemicals), a nonstabilised sample being included as reference. These coating compositions were applied to sheets of cold roll steel having been coated by a metallic basecoat before, to give a dry film thickness of from 20 μm to 30 μm after drying for 30 minutes at 80° C.

TABLE 3
Coating formulations

| Constituents† | E | | F | | G | | H | |
|---|---|---|---|---|---|---|---|---|
| Acrylic Resin* | 80 | g | 80 | g | 80 | g | 80 | g |
| Acrylic Flow Agent†† | 2 | g | 2 | g | 2 | g | 2 | g |
| Silicone Flow Agent‡ | 2 | g | 2 | g | 2 | g | 2 | g |
| DBTL (1%)** | 0.5 | g | 0.5 | g | 0.5 | g | 0.5 | g |
| UV-3 | 1.5 | g | — | | — | | — | |
| UV-4 | — | | 1.5 | g | — | | — | |
| Comp. Light Stabiliser††† | — | | — | | 1.5 | g | — | |
| HALS*** | 0.7 | g | 0.7 | g | 0.7 | g | 0.7 | g |
| Polyisocyanate‡‡ | 37.7 | g | 37.7 | g | 37.7 | g | 37.7 | g |

†a solvent mixture of dicarboxylic acid esters (4 g), aromatic hydrocarbons (4 g), “PM Acetate” (propylene glycol monomethylether acetate, 4 g) and butyl acetate (2.8 g) was added to all formulations
*hydroxyfunctional acrylic resin dissolved in butyl acetate, mass fraction of solids 70%, hydroxyl number 151 mg/g
††hydroxyfunctional acrylic flow modifier dissolved in butyl acetate, mass fraction of solids 10%
‡modified silicone, dissolved in butyl acetate, mass fraction of solids 10%
**solution of dibutyl-tin-dilaurate in butyl acetate (mass fraction of tin 0.08%)
†††benzotriazole type light stabiliser (®Tinuvin 1130, Ciba Specialty Chemicals)
***hindered amine light stabilizer (®Tinuvin 292, Ciba Specialty Chemicals)
‡‡It HDI based polyisocyanate, mass fraction of solids 75%, mass fraction of NCO groups 16.5%

The mass fraction of the benzotriazole moiety in composition E is approximately 5 fold compared to the one in composition G. Composition H is a nonstabilised control. These coated steel panels (panel E coated with coating composition E, panel F coated with coating composition F, panel G coated with coating composition G, panel H coated with coating composition H) were subjected to a QUV Weathering Test (Q-Lab, wave length: 313 nm, cycles of 4 hours of irradiation at 50° C. followed by four hours of water spray at 40° C.). Change in yellowness in the coating film was monitored after a specified exposure time, the results are compiled in table 2.

Yellowness (Δb) was measured with a customary instrument (BYK Gardner Spectrophotometer) and calculated according to ASTM E 313.

TABLE 2
Change in yellowness (Δb) after irradiation

| Δb after | 168 h | 336 h | 504 h | 672 h | 840 h |
|---|---|---|---|---|---|
| Panel A | 1.54 | 1.98 | 2.16 | 2.45 | 2.85 |
| Panel B | 1.62 | 1.78 | 1.80 | 2.20 | 2.51 |
| Panel C | 1.48 | 1.85 | 2.26 | 2.28 | 2.54 |
| Panel D | 1.74 | 2.55 | 2.94 | 3.36 | 4.51 |

It can be seen that although the mass fraction of the stabilising structure, benzotriazole, in coating composition E is only 20% of that of coating composition G, yellowing caused by UV light is in the same range for both panels. It can also be seen that coating composition F (containing a triazine type light stabiliser chemically bound to the amphiphilic polymer) shows less yellowing than the other panels.

### Example 7

### Intermediate for a Water-Dispersible Polymeric Light Stabiliser

A glass reactor having a volume of 1000 ml equipped with reflux condenser and stirrer was charged with 164 g of methoxypropylacetate and 271.5 g of 3-[3-(2H-benzotriazol-2-yl)-5-tert-butyl-4-hydroxyphenyl]propionic acid (acid functional benzotriazole, CAS#84268-36-0). 0.5 g of hydroquinone monomethylether and 113.7 g of glycidylmethacrylate were added and heated up to 130° C. while steadily blowing air through the reaction mixture. The reaction temperature was maintained until the acid number (measured according to DIN EN ISO 2114) was less than 5 mg/g. The resulting product had a mass fraction of solids of 72%.

### Example 8

### Water-Dispersible Polymeric Light Stabiliser

A glass reactor having a volume of 500 ml equipped with reflux condenser, stirrer, and two feeding pumps was charged with 18 g of n-butanol and 18 g of methoxypropanol. The contents were heated to 115° C., and a mixture of 1.0 g of di-t-butylperoxide, 6.5 g of n-butanol, 6.5 g of methoxypropanol, 29.0 g of butyl acrylate, 10.0 g of acrylic acid, 30 g of hydroxyethyl acrylate, 3.0 g of perfluoroalkylethyl acrylate (®Fluowet AC 600, Clariant Deutschland GmbH) and 40 g of the product of example 7 was gradually added over six hours. The mixture was kept at 115° C. under stirring for another 2 hours, and then, a second mixture of 0.2 g of di-t-butylperoxide and 1.0 g of n-butanol was added to the reaction mixture. Reaction was then brought to completion by keeping the mixture at 115° C. for one more hour. The temperature was then reduced to 80° C., and 12 g of N,N-dimethyl ethanolamine and 20 g of deionised water were added. Further deionised water was added to adjust the mass fraction of solids to 48%. A clear yellow solution with a pH (measured on an aqueous solution having a mass fraction of solids of 10%) of 8.6 and a dynamic viscosity of 6400 mPa·s was obtained.

A steel panel was coated with an aqueous dispersion of an acrylic resin having 1.5 g of the stabiliser of the example per 80 g of solids of the acrylic resin in the dispersion was subjected to the weathering test described in Example 6. Measurement of the change in yellowness (Δb) after irradiation for 700 h gave a value of 2.5. This performance was similar to that shown for solvent-borne resins.

What is claimed is:

1. A light stabiliser AS comprising a surface-active or amphiphilic part A which leads to migration of the stabiliser to the surface of a material during the process of formation of a surface, and solidification of the material, and a stabilising part S which is the photochemically active ingredient and transforms the energy of the incident light to vibrational or heat energy that is dissipated within the material, characterised in that both parts are connected by a chemical bond in the form of a single or multiple bond or of an at least divalent bridging group.

2. The light stabiliser of claim 1 wherein the surface-active or amphiphilic part is an oligomer or polymer selected from the group consisting of vinyl polymers, polymers comprising siloxane moieties, and polymers comprising difluoromethylene (—CF₂—) units.

3. The light stabiliser of claim 1 wherein the stabilising part comprises a moiety having a structure selected from the group consisting of a hindered amine structure, a benzophenone structure, a benzotriazole structure, and a triazine structure.

4. The light stabiliser of claim 1 wherein the at least divalent bridging group comprises at least one structure of the formula —CR¹R²—CR³R⁴—, wherein any of the radicals —R¹, —R², —R³ and —R⁴ is, independently of each other, selected from the group consisting of the radicals —H, —F, —Cl, —CH₃, —OH, —OCH₃, an alkyl radical —CₙH₂ₙ₊₁, an oxyalkyl radical —O—CₙH₂ₙ₊₁, where n is in each case independently, from 2 to 18, an aryl radical, and an oxyaryl radical.

5. The light stabiliser of claim 1 wherein the surface-active or amphiphilic part is selected from the group consisting of an oligomer or polymer of vinyl polymers, an oligomer or polymer comprising siloxane moieties, an oligomer or polymer comprising difluoromethylene (—CF₂—) units, and the stabilising part has a hindered amine structure.

6. The light stabiliser of claim 1 wherein the surface-active or amphiphilic part is selected from the group consisting of an oligomer or polymer of vinyl polymers, an oligomer or polymer comprising siloxane moieties, an oligomer or polymer comprising difluoromethylene (—CF₂—) units, and the stabilising part has a benzophenone structure.

7. The light stabiliser of claim 1 wherein the surface-active or amphiphilic part is selected from the group consisting of an oligomer or polymer of vinyl polymers, an oligomer or polymer comprising siloxane moieties, an oligomer or polymer comprising difluoromethylene (—CF₂—) units, and the stabilising part has a benzotriazole structure.

8. The light stabiliser of claim 1 wherein the surface-active or amphiphilic part is selected from the group consisting of an oligomer or polymer of vinyl polymers, an oligomer or polymer comprising siloxane moieties, an oligomer or polymer comprising difluoromethylene (—CF₂—) units, and the stabilising part has a triazine structure.

9. A method of use of the light stabiliser of claim 1, comprising adding the said stabiliser to a thermoplastic polymer in a mass fraction of from 0.1% to 5%, based on the sum of the masses of the said thermoplastic polymer and the said light stabiliser, melting the mixture of the said thermoplastic polymer and the said light stabiliser, mixing the molten mixture, and solidifying the molten mixture by cooling.

10. A method of use of the light stabiliser of claim 1, comprising adding the said stabiliser to a thermosetting polymeric material in a mass fraction of from 0.1% to 5%, based on the sum of the masses of the said thermosetting polymeric material and the said light stabiliser, heating the mixture of the said thermosetting polymeric material and the said light stabiliser to a temperature below the curing temperature of the said thermosetting polymer, mixing the molten mixture, and solidifying the molten mixture by heating to a temperature equal or greater than the curing temperature of the said thermosetting polymeric material.

11. A method of use of the light stabiliser of claim 1, comprising adding the said stabiliser to a crosslinkable polymeric binder dissolved in an organic solvent in a mass fraction of from 0.1% to 5%, based on the sum of the masses of the said crosslinkable polymeric binder and the said light stabiliser, to form a coating composition, mixing the said coating composition, applying the mixed coating composition to a substrate to form a film on the substrate, heating the coated substrate to a temperature sufficient to remove at least a part of the solvent, and crosslinking the said film on the said substrate by heating or subjecting the coated substrate to radiation.

12. A method of use of the light stabiliser of claim 1, comprising adding the said stabiliser to a crosslinkable polymeric binder dispersed or emulsified in water in a mass fraction of from 0.1% to 5%, based on the sum of the masses of the said crosslinkable polymeric binder and the said light stabiliser, to form a coating composition, mixing the said coating composition, applying the mixed coating composition to a substrate to form a film on the substrate, heating the coated substrate to a temperature sufficient to remove at least a part of the solvent, and crosslinking the said film on the said substrate by heating or subjecting the coated substrate to radiation.
